(19) United States
(12) Patent Application Publication
(10) Pub. No.: US 2007/0046133 A1
(43) Pub. Date: Mar. 1, 2007

(54) Rotor for automotive alternator having barrier to prevent entrance of foreign matters

(75) Inventor: Kazutoshi Nakano, Kariya-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/504,647

(22) Filed: Aug. 16, 2006

(30) Foreign Application Priority Data
Aug. 26, 2005 (JP) 2005-246351

(51) Int. Cl. H01R 39/08

(52) U.S. Cl. 310/232; 310/263

(57) ABSTRACT

According to the invention, a rotor for an automotive alternator includes a slip ring assembly, a rotary shaft, and a barrier. The slip ring assembly includes an insulating member that has a slip-ring holding portion with a hollow cylindrical shape, a terminal holing portion with an annular shape, and a connecting portion connecting the slip-ring holding portion to the terminal holding portion. The rotary shaft includes a first portion fitted in the slip-ring holding portion of the insulating member, a second portion having the connecting portion of the insulating member fitted thereon with part of the outer surface thereof being exposed to outside of the insulating member, and a third portion fitted in the terminal holding portion of the insulating member. The barrier is provided to prevent foreign matters from entering a clearance between the terminal holing portion of the insulating member and the third portion of the rotary shaft.

### CROSS-REFERENCE TO RELATED APPLICATION

This application is based on and claims priority from Japanese Patent Application No. 2005-246351, filed on Aug. 26, 2005, the content of which is hereby incorporated by reference into this application.

### BACKGROUND OF THE INVENTION

1 Technical Field of the Invention The present invention relates generally to rotors for automotive alternators. More particularly, the invention relates to a rotor for an automotive alternator in which a barrier is provided to prevent foreign matters from entering a clearance between a slip ring assembly and a rotary shaft.

2 Description of the Related Art

In automotive alternators, field current is generally supplied from a battery or a rectifier to a field winding via slip rings that are provided on a rotary shaft of a rotor, thus causing the rotor to create a rotating magnetic field.

There are two different methods of providing the slip rings on the rotary shaft. The first method is to integrally form the slip rings with the rotary shaft. The second method is to prepare a slip ring assembly, which includes the slip rings, and the rotary shaft severally and then fit the slip ring assembly onto the rotary shaft. (The second method is disclosed, for example, in U.S. Pat. No. 6,858,966.)

FIGS. 7 and 8 show part of an existing rotor for an automotive alternator which is obtained by the second method. As shown in these figures, the existing rotor includes a rotary shaft 110 and a slip ring assembly that is configured with a pair of sling rings 100, a pair of leads 102, a pair of terminals 104, and an insulating member 106.

The insulating member 106 includes a slip-ring holding portion 106a, a terminal holding portion 106c, and two connecting portion 106b connecting the slip-ring holding portion 106a to the terminal holing portion 106c. The slip-ring holding portion 106a has a hollow cylindrical shape and holds the slip rings 100 on the outer surface thereof so as to insulate the slip rings 100 from one another. The terminal holding portion 106c has a substantially annular shape and is coaxial with the slip-ring holding portion 106a. The terminal holding portion 106c holds the terminals 104, which are to be connected to a field winding of the rotor, on the outer surface thereof so as to insulate the terminals 104 from one another. Each of the connecting portions 106b has a predetermined width in the circumferential direction of the slip-ring holding portion 106a and extends from the slip-ring holding portion 106a to the terminal holding portion 106c in the axial direction. The insulating member 106 has embedded therein the leads 102 so as to electrically insulate the leads 102 from one another. More specifically, each of the leads 102 has one end connected to a corresponding one of the slip rings 100 and the other end connected a corresponding one of the terminals 104. Each of the leads 102 extends, from the corresponding slip ring 100, first axially in the slip-ring holding portion 106a and a corresponding one of the connecting portions 106b of the insulating member 106, and then radially in the terminal holding portion 106c of the insulating member 106 to the corresponding terminal 104.

The rotary shaft 110 has a first portion 110a and a second portion 110b. The first portion 110a is fitted in the slip-ring holding portion 106a of the insulating member 106. The second portion 110b has the connecting portions 106b and the terminal holding portion 106c of the insulating member 106 fitted thereon, so that part of the outer surface of the second portion 110b is exposed to outside of the insulating member 106.

Further, as shown in FIG. 8, the second portion 110b of the rotary shaft 110 has an outer diameter d1 smaller than an inner diameter d2 of the terminal holding portion 106c of the insulating member 106, so that there is a clearance S between the outer surface of the second portion 11b of the rotary shaft 110 and the inner surface of the terminal holding portion 106c of the insulting member 106.

With the above configuration of the existing rotor, it is easy for foreign matters (e.g., rain water) to enter the clearance S along the exposed part of the outer surface of the second portion 110b of the rotary shaft 110 and accumulate therein. Further, since the terminals 104 in the vicinity of the clearance S are exposed to outside of the insulating member 106, it is easy for the foreign matters accumulated in the clearance S to cause an insulation failure between the terminals 104 and the rotary shaft 110 or a rotor core 114 of the rotor.

### SUMMARY OF THE INVENTION

The present invention has been made in view of the above-mentioned problem.

It is, therefore, a primary object of the present invention to provide a rotor for an automotive alternator which has an improved structure and is thereby capable of preventing foreign matters from entering a clearance between a slip ring assembly and a rotary shaft thereof.

According to the present invention, there is provided a rotor for an automotive alternator which includes a rotor, a field winding, a slip ring assembly, a rotary shaft, and a barrier.

The field winding is wound around the rotor core and has a pair of opposite ends.

The slip ring assembly includes a pair of slip rings, a pair of leads, a pair of terminals each of which is connected to one of the ends of the field winding, and an insulating member. The insulating member includes a slip-ring holding portion, a terminal holing portion, and a connecting portion connecting the slip-ring holding portion to the terminal holding portion. The slip-ring holding portion has a hollow cylindrical shape and holds the slip rings on an outer surface thereof. The terminal holding portion has a substantially annular shape and holds the terminals on an outer surface thereof. The connecting portion extends from part of the slip-ring holding portion to part of the terminal holding portion. The insulting member has embedded therein the leads such that each of the leads has one end connected to a corresponding one of the slip rings and the other end connected to a corresponding one of the terminals.

The rotary shaft has the rotor core and the slip ring assembly fixed thereon. The rotary shaft includes a first portion, a second portion, and a third portion. The first portion is fitted in the slip-ring holding portion of the insulating member. The second portion has the connecting portion of the insulating member fitted thereon with part of an outer surface of the second portion being exposed to outside of the insulating member. The third portion is fitted in the terminal holding portion of the insulating member.

The barrier is provided to prevent foreign matters from entering a clearance between the terminal holing portion of the insulating member and the third portion of the rotary shaft.

In the above rotor according to the present invention, it is possible to prevent, with the barrier, foreign matters from entering the clearance between the terminal holing portion of the insulating member and the third portion of the rotary shaft. Consequently, it becomes possible to prevent any insulation failure between the terminals and the rotary shaft or the rotor core.

According to a further implementation of the present invention, the third portion of the rotary shaft has a greater outer diameter than the second portion of the rotary shaft to define a step at an interface between the second and third portions of the rotary shaft. The step serves as the barrier to prevent foreign matters from entering the clearance between the terminal holing portion of the insulating member and the third portion of the rotary shaft along the exposed part of the outer surface of the second portion of the rotary shaft.

The rotor further includes a cooling fan which is fixed to an axial end of the rotor core to create a cooling air flow that passes the exposed part of the outer surface of the second portion of the rotary shaft toward the third portion of the rotary shaft.

In this case, foreign matters, such as rain water, may be mixed in the cooling air and move, with the cooling air flow, along the exposed part of the outer surface of the second portion of the rotary shaft toward the third portion. However, with the provided barrier (i.e., the step), it is possible to prevent the foreign matters from further entering the clearance between the terminal holing portion of the insulating member and the third portion of the rotary shaft.

The connecting portion of the insulating member is composed of a pair of separated branch portions. Each of the leads extends, from the corresponding slip ring, first axially in the slip-ring holing portion and a corresponding one of the branch portions, and then radially in the terminal holding portion of the insulating member to the corresponding terminal.

The rotor is for use in an automotive alternator which is designed to be used with the rotary shaft of the rotor being substantially parallel to a horizontal direction.

In this case, it is particularly effective to prevent foreign matters from entering the clearance between the terminal holing portion of the insulating member and the third portion of the rotary shaft by means of the step defined at the interface between the second and third portions of the rotary shaft.

### BRIEF DESCRIPTION OF THE DRAWINGS

The present invention will be understood more fully from the detailed description given hereinafter and from the accompanying drawings of the preferred embodiment of the invention, which, however, should not be taken to limit the invention to the specific embodiment but are for the purpose of explanation and understanding only.

In the accompanying drawings:

FIG. 1 is a partially cross-sectional side view showing the overall structure of a rotor for an automotive alternator according to an embodiment of the invention;

FIG. 2 is a top view showing a slip ring assembly of the rotor of FIG. 1 before its assembly into the rotor;

FIG. 3 is a partially cross-sectional side view showing the rotor of FIG. 1 without the slip ring assembly;

FIG. 4 is a top view showing a rotary shaft of the rotor of FIG. 1 with the slip ring assembly fitted thereon;

FIG. 5 is a cross-sectional view taken along the line I-I in FIG. 1;

FIG. 6 is a cross-sectional view taken along the line II-II in FIG. 1;

FIG. 7 is a top view showing a slip ring assembly and a rotary shaft of a prior art rotor for an automotive alternator; and

FIG. 8 is a cross-sectional view taken along the line I-I in FIG. 7.

### DESCRIPTION OF THE PREFERRED EMBODIMENT

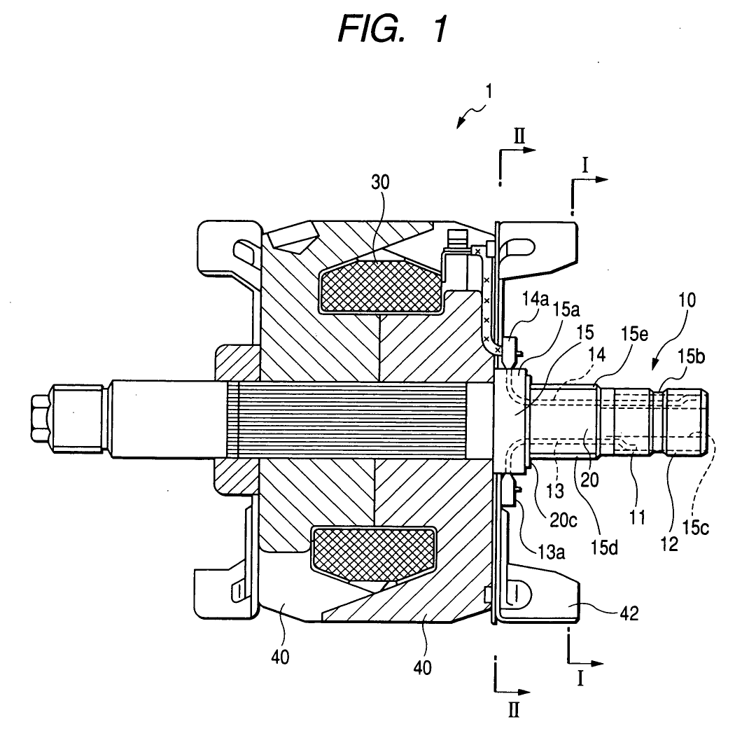

The preferred embodiment of the present invention will be described hereinafter with reference to FIGS. 1-6.

It should be noted that, for the sake of clarity and understanding, identical components having identical functions have been marked with the same reference numerals in each of the figures.

FIG. 1 shows the overall structure of a rotor 1 for an automotive alternator according to an embodiment of the present invention.

As shown in FIG. 1, the rotor 1 includes a slip ring assembly 10, a rotary shaft 20, a field winding 30, a rotor core 40, and a cooling fan 42.

The slip ring assembly 10 is configured with a pair of slip rings 11 and 12, a pair of leads 13 and 14, a pair of terminals 13a and 14a, and an insulating member 15. The terminals 13a and 14a are connected to a pair of opposite ends of the field winding 30, respectively.

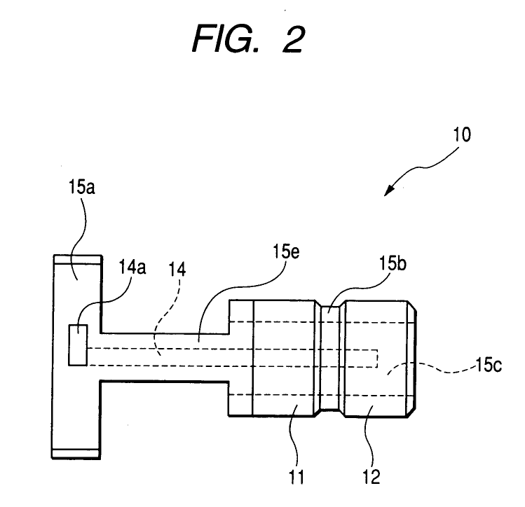

Referring further to FIG. 2, the insulating member 15 includes a terminal holing portion 15a, a slip-ring holing portion 15b, and a pair of connecting portions 15d and 15e.

The slip-ring holding portion 15b of the insulating member 15 has the shape of a hollow cylinder; thus it has a hollow space 15 defined therein. The slip-ring holing portion 15b holds the slip rings 11 and 12 on the outer surface thereof so as to electrically insulate the slip rings 11 and 12 from one another. More specifically, the slip rings 11 and 12 are coaxially fixed on the outer surface of the slip-ring holding portion 15b with a predetermined axial distance therebetween. The slip ring 11 is positioned closer to the terminal holding portion 15a of the insulating member 15 than the slip ring 12.

The terminal holding portion 15a of the insulating member 15 has a substantially annular shape and is coaxial with the slip-ring holding portion 15b. The terminal holding portion 15a of the insulating member 15 holds the terminals 13a and 14a on the outer surface thereof so as to electrically insulate the terminals 13a and 14a from each other. More specifically, the terminals 13a and 14a are fixed on the outer surface of the terminal holding portion 15a such that they are apart from each other by about 180° in the circumferential direction of the terminal holding portion 15a.

Each of the connecting portions 15d and 15e has the shape of a bar with a predetermined width. In other words, each of the connecting portions 15d and 15e has a predetermined width in the circumferential direction of the terminal holding portion 15a. The connecting portions 15d and 15e extend in the axial direction to connect the slip-ring holding portion 15b to the terminal holding portion 15a, and are apart from each other by about 180° in the circumferential direction.

The insulating member 15 has embedded therein the leads 13 and 14 such that the leads 13 and 14 are electrically insulated from each other and has one end connected to a corresponding one of the slip rings 11 and 12 and the other end connected to a corresponding one of the terminals 13a and 14a. More specifically, the lead 13 extends, from the slip ring 11, first axially in the slip-ring holding portion 15b and the connecting portion 15d of the insulating member 15, and then radially in the terminal holding portion 15a of the insulating member 15 to the terminal 13a. Similarly, the lead 14 extends, from the slip ring 12, first axially in the slip-ring holding portion 15b and the connecting portion 15e of the insulating member 15, and then radially in the terminal holding portion 15a of the insulating member 15 to the terminal 14a.

In addition, brazing or welding may be used to connect the one ends of the leads 13 and 14 respectively to the slip rings 11 and 14. More over, the other ends of the leads 13 and 14 may be configured to radially protrude out of the terminal holding portion 15a of the insulating member 15 to form the terminals 13a and 14a, respectively. In other words, the leads 13 and 14 may be integrally formed with the terminals 13a and 14a, respectively.

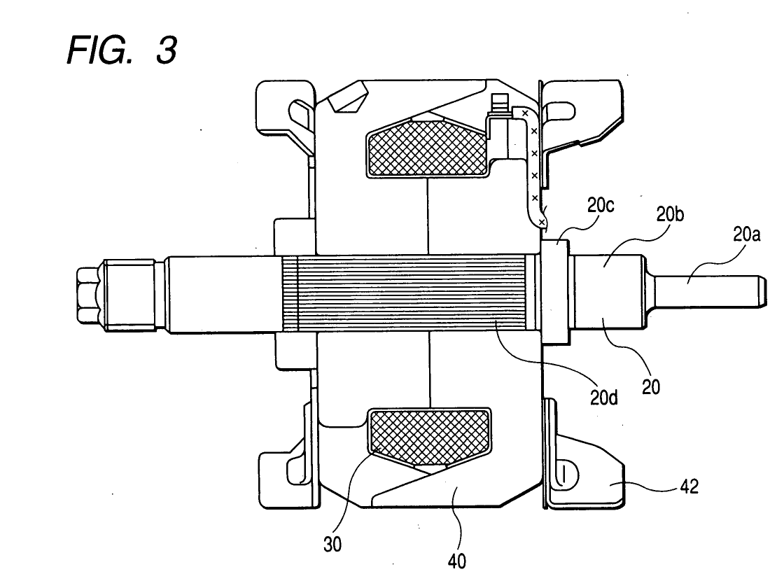

FIG. 3 shows the rotary shaft 20 without the slip ring assembly 10 fitted thereon.

As shown in FIG. 3, the rotary shaft 20 includes a first portion 20a, a second portion 20b, a third portion 20c, and a fourth portion 20d. In the present embodiment, the rotary shaft 20 is configured such that the third portion 20c has the maximum outer diameter among those portions 20a-20d. Accordingly, there is formed a step at the interface between the second portion 20b and the third portion 20c of the rotary shaft 20.

The rotary shaft 20 has a plurality of knurls that are formed on the outer surface of the fourth portion 20d along the axial direction. On the knurled fourth portion 20d of the rotary shaft 20, there is press-fitted the rotor core 40.

Further, the filed winding 40, which is to be connected to the terminals 13 and 14 of the slip ring assembly 10, is wound around the rotor core 40. The cooling fan 42 is fixed by, for example, welding to the one of axial ends of the rotor core 40 which is closer to the slip ring assembly 10.

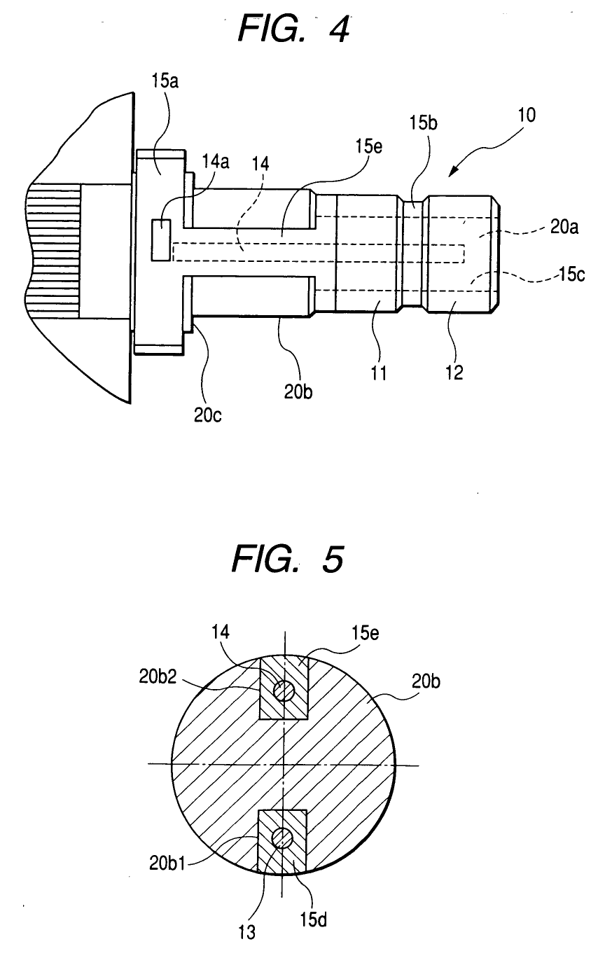

FIG. 4 shows the rotary shaft 20 with the slip ring assembly 10 fitted thereon.

As shown in FIG. 4, the first portion 20a of the rotary shaft 20 is fitted in the hollow space 15c defined in the slip-ring holding portion 15b of the insulating member 15 of the slip ring assembly 10.

Referring further to FIG. 5, the connecting portions 15d and 15e of the insulating member 15 of the slip ring assembly 10 is fitted in recesses 20b1 and 20b2 formed in the second portion 20b of the rotary shaft 20, so that most part of the outer surface of the second portion 20b is exposed to outside of the insulting member 15.

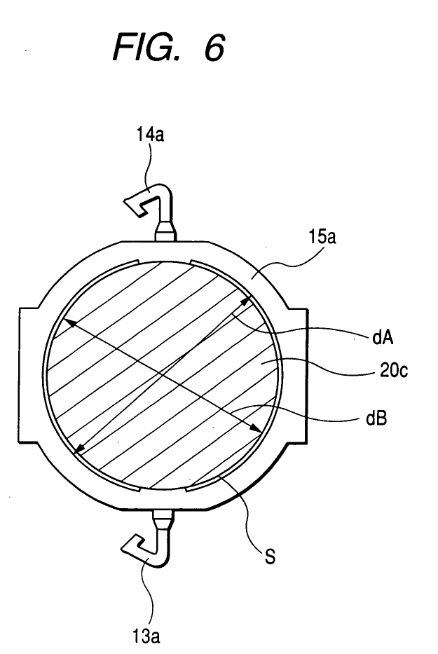

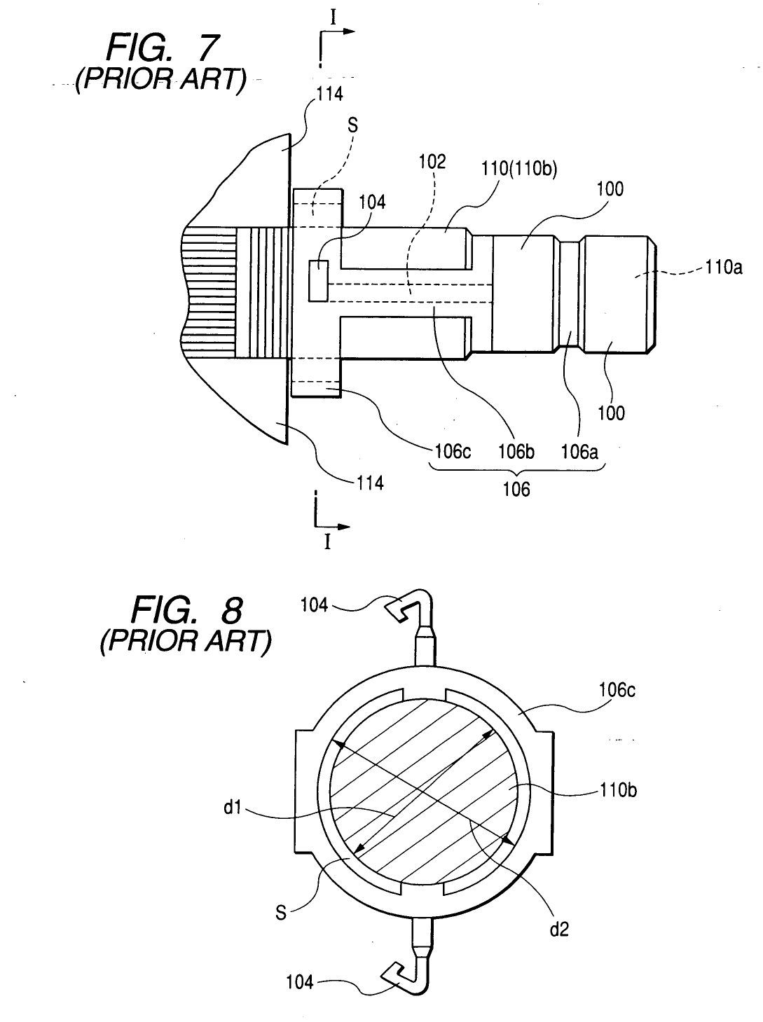

Referring to FIG. 6, the terminal holding portion 15a of the insulating member 15 of the slip ring assembly 10 is fitted on the third portion 20c of the rotary shaft 20. The terminal holding portion 15a of the insulating member 15 has an inner diameter dA that is greater than an inner diameter dB of the third portion 20C of the rotary shaft 20. Accordingly, there is defined a clearance S between the terminal holding portion 15a of the insulating member 15 and the third portion 20c of the rotary shaft 20; the clearance S has a radial width of (dA−dB)/2.

In practical use, the above-described rotor 1 according to the present embodiment is assembled into an automotive alternator. The automotive alternator is further installed to an automobile such that the rotary shaft 20 of the rotor 1 is substantially parallel to a horizontal direction.

During operation of the automotive alternator, the cooling fan 42 rotates with rotation of the rotor 1 to suck in cooling air in the axial direction of the rotary shaft 20 and discharge out the same in the radial direction.

Thus, the cooling air flow created by the cooling fan 42 will pass the exposed part of the outer surface of the second portion 20b of the rotary shaft 20 toward the third portion 20c.

In some cases, foreign matters, such as rain water, may be mixed in the cooling air and move, with the cooling air flow, along the exposed part of the outer surface of the second portion 20b of the rotary shaft 20 toward the third portion 20c.

If the third portion 20c of the rotary shaft 20 has, as in the previously-described existing rotor, the same outer diameter as the second portion 20b, the foreign matters would enter the clearance S between the terminal holding portion 15a of the insulating member 15 and the third portion 20c of the rotary shaft 20, thus causing an insulation failure between the terminals 13a and 14a and the rotary shaft 20 or the rotor core 40.

However, in the rotor 1 according to the present embodiment, there is provided a barrier to prevent foreign matters from entering the clearance S between the terminal holding portion 15a of the insulating member 15 and the third portion 20c of the rotary shaft 20.

More specifically, in the rotor 1, the third portion 20c of the rotary shaft 20 has the greater outer diameter than the second portion 20b of the same to define the step at the interface between the second and third portions 20b and 20c. The step serves as the barrier to prevent foreign matters from entering the clearance S along the exposed part of the outer surface of the second portion 20b of the rotary shaft 20.

Consequently, with the provided barrier (i.e., the step in the present embodiment), it becomes possible to prevent any insulation failure between the terminals 13a and 14a and the rotary shaft 20 or the rotor core 40.

While the above particular embodiment of the invention has been shown and described, it will be understood by those who practice the invention and those skilled in the art that various modifications, changes, and improvements may be made to the invention without departing from the spirit of the disclosed concept.

For example, in the previous embodiment, the second and third portions 20b and 20c of the rotary shaft 20 have the different outer diameters; the barrier for preventing foreign matters from entering the clearance S between the terminal holding portion 15a of the insulating member 15 and the third portion 20c of the rotary shaft 20 is provided in the form of the step defined at the interface between the second and third portions 20b and 20c.

However, the second and third portions 20b and 20c of the rotary shaft 20 may have the same outer diameter; the barrier for preventing foreign matters from entering the clearance S between the terminal holding portion 15a of the insulating member 15 and the third portion 20c of the rotary shaft 20 may be provided in other forms, such as a metal or resin band that is fixed to the outer surface of the second portion 20b and extends along the circumferential direction at the entrance to the clearance S.

Such modifications, changes, and improvements are possible within the scope of the appended claims.

What is claimed is:

1. A rotor for an automotive alternator, comprising:
a rotor core;
a field winding wound around the rotor core, the field winding having a pair of opposite ends;
a slip ring assembly including a pair of slip rings, a pair of leads, a pair of terminals each of which is connected to one of the ends of the field winding, and an insulating member, the insulating member including a slip-ring holding portion, a terminal holing portion, and a connecting portion connecting the slip-ring holding portion to the terminal holding portion, the slip-ring holding portion having a hollow cylindrical shape and holding the slip rings on an outer surface thereof, the terminal holding portion having a substantially annular shape and holding the terminals on an outer surface thereof, the connecting portion extending from part of the slip-ring holding portion to part of the terminal holding portion, the insulting member having embedded therein the leads such that each of the leads has one end connected to a corresponding one of the slip rings and the other end connected to a corresponding one of the terminals;
a rotary shaft having the rotor core and the slip ring assembly fixed thereon, the rotary shaft including a first portion, a second portion, and a third portion, the first portion, being fitted in the slip-ring holding portion of the insulating member, the second portion having the connecting portion of the insulating member fitted thereon with part of an outer surface of the second portion being exposed to outside of the insulating member, the third portion being fitted in the terminal holding portion of the insulating member; and
a barrier provided to prevent foreign matters from entering a clearance between the terminal holing portion of the insulating member and the third portion of the rotary shaft.

2. The rotor as set forth in claim 1, wherein the third portion of the rotary shaft has a greater outer diameter than the second portion of the rotary shaft to define a step at an interface between the second and third portions of the rotary shaft, the step serving as the barrier to prevent foreign matters from entering the clearance between the terminal holing portion of the insulating member and the third portion of the rotary shaft along the exposed part of the outer surface of the second portion of the rotary shaft.

3. The rotor as set forth in claim 1, further comprising a cooling fan which is fixed to an axial end of the rotor core to create a cooling air flow that passes the exposed part of the outer surface of the second portion of the rotary shaft toward the third portion of the rotary shaft.

4. The rotor as set forth in claim 1, wherein the connecting portion of the insulating member is composed of a pair of separated branch portions, and wherein each of the leads extends, from the corresponding slip ring, first axially in the slip-ring holing portion and a corresponding one of the branch portions, and then radially in the terminal holding portion of the insulating member to the corresponding terminal.

5. The rotor as set forth in claim 1, wherein the rotor is for use in an automotive alternator which is designed to be used with the rotary shaft of the rotor being substantially parallel to a horizontal direction.
